(19) United States
(12) Patent Application Publication
(10) Pub. No.: US 2003/0201407 A1
(43) Pub. Date: Oct. 30, 2003

(54) Transmission sensor

(75) Inventors: Larry S. Atherton, Anoka, MN (US); Donald S. Foreman, Fridley, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/134,290

(22) Filed: Apr. 29, 2002

(51) Int. Cl. G01V 8/00; G01N 21/86

(52) U.S. Cl. 250/559.13

(57) ABSTRACT

A transmitivity sensor having a light source and a detector on one side of a medium with a reflector on the other side of the medium so as to reflect the light from the light source back through the medium to the detector. For instance, the sensor may be used on a window of a sealed building or container without having connections to the source and detector break the integrity of the window seal relative to the building or the container. The magnitude of the light signal on the detector relative to that of the source is an indication of the transmitivity of the window. Electronics to effectively implement the sensor are connected to the source and detector. The electronics may contain, for example, a source driver, a detector amplifier, a band-pass filter, a logarithmic amplifier and various voltage sources. Other items may be a part of the electronics as desired.

### BACKGROUND

The invention is a device for measuring the transmittance of a window, and in particular for that of an electrochromic window. An electrochromic window is one whose light transmittance can be varied electronically.

There are such sensors in the art; however, none appears to retain the integrity of the window seal against an outside environment in an effective manner as the present invention.

### SUMMARY

The invention has a transmission sensor at one side of a window of which the transmittance is measured. Preferably, if the window is that of a container or building, the transmission sensor is on the side of the window within or outside the container or building, but this is not required. On the other side of the window is a reflector which is aligned with the sensor such that an emitting signal from the transmission sensor goes through the window and is reflected back through the window to the transmission sensor. The arrangement could be different.

### BRIEF DESCRIPTION OF THE DRAWINGS

FIG. 1 shows an illustrative embodiment of the transmission sensor.

FIG. 2 is a block diagram of the electronics of the transmission sensor of FIG. 1.

FIG. 3 is an electronic schematic of the transmission sensor of FIG. 1.

### DESCRIPTION

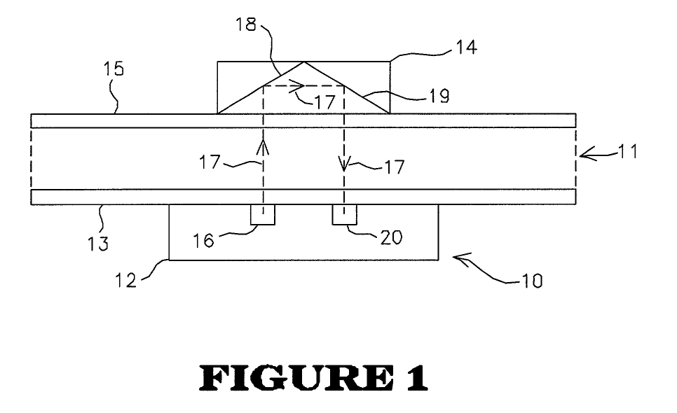

FIG. 1 shows an illustrative transmission assembly 10 associated with a window 11 that is being measured for light transmittance. Electronic module 12 is attached or otherwise positioned adjacent to one side 13 of window 11. In the illustrative embodiment, corner reflector 14 or the like is attached or otherwise positioned adjacent to the other side 15 of window 11. A light source, such as a light emitting diode (LED) 16, vertical cavity surface emitting laser (VCSEL), or any other suitable light source, emits light 17 through panes or sides 13 and 15, respectively, of window 11. Window 11 is shown with two panes, but it could have one pane or any other number of panes. In the illustrative embodiment, light 17 is reflected by surface 18 to surface 19 of corner reflector 14. Surface 19 reflects light 17 through sides 15 and 13, respectively, of window 11. Light 17 then impinges on a photoreceptor 20. The electronics of module 12 determines the amount of transmittance of window 11 in accordance with the intensity, polarization, wavelength or other characteristic, or change thereof, of light 17 at detector 20.

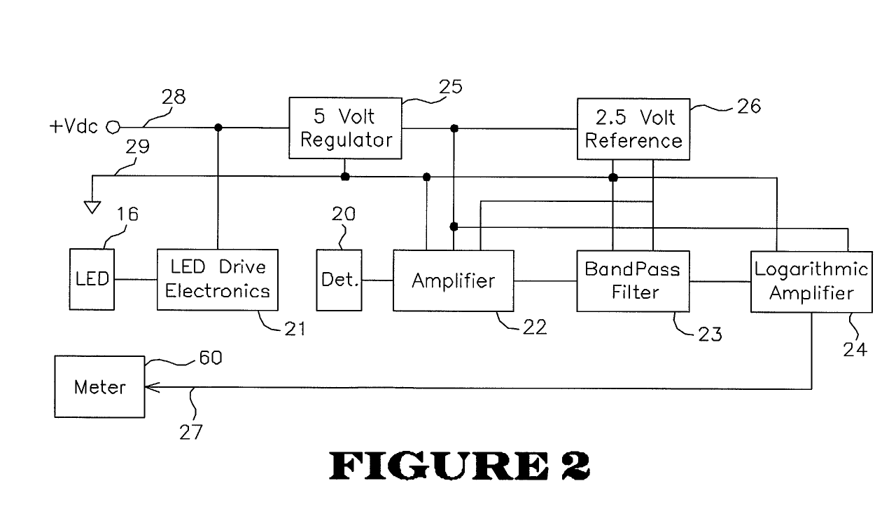

FIG. 2 is a block diagram of the electronics for the illustrative transmittance sensor 10 of FIG. 1. Drive electronics 21 is connected to a light source, which in this case is LED 16. The output of detector 20 goes to detector amplifier 22. The detector 20 may be any suitable light detector, including a photo diode, resonant cavity photo detector (RCPD), or any other type of light detector. The output of amplifier 22 goes to a bandpass filter 23. The output of filter 23 goes to a logarithmic amplifier 24. In the illustrative embodiment, an output 27 of amplifier 24 has an electrical magnitude, phase, frequency or other characteristic that is indicative of the light level and resultant transmittance of window 11. Output 27 goes to a meter or readout instrumentation 60 which may include a processor. In the illustrative embodiment, a five volt supply is provided by regulator 25 to amplifiers 22 and 24. A 2.5 volt supply is provided by regulator 26 to amplifier 22 and filter 23. An external voltage supply line 28 provides +Vdc to the sensor electronics. Line 29 is the ground for system 10.

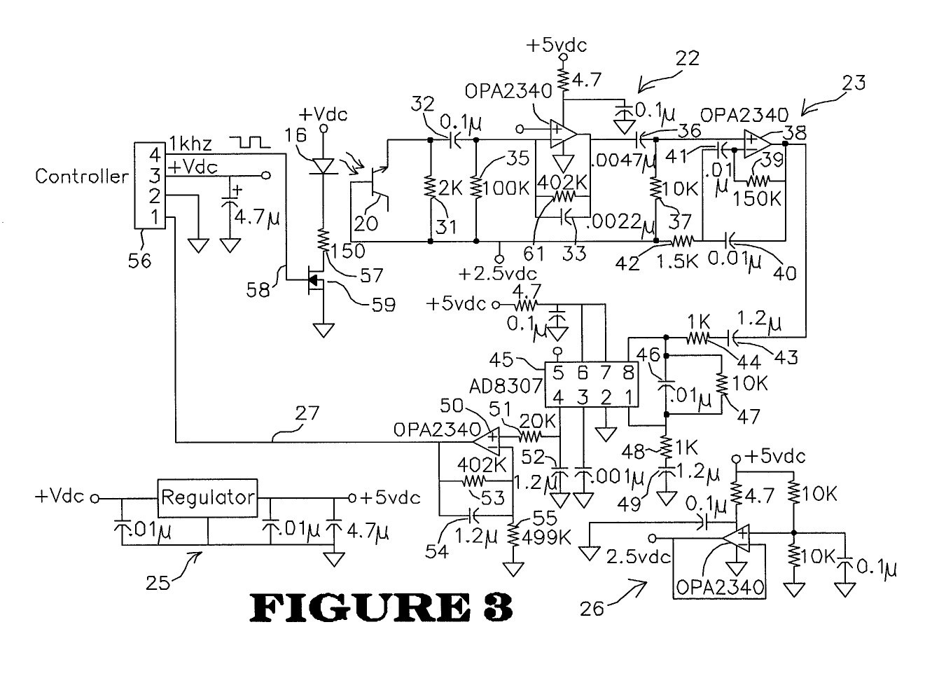

FIG. 3 is a schematic of the electronics for the illustrative transmittance sensor 10 of FIG. 1. LED 16 provides light via a path 17 shown in FIG. 1 to detector 20. In the embodiment shown, the anode of LED 16 is connected to +Vdc, and the cathode is connected through a 150 ohm resistor 57 to the drain of a MOSFET 59 having a source connected to ground. The gate of the MOSFET is driven by a one kilohertz square wave on a line 58 from a controller or microprocessor 56. LED 16 is modulated at a current from zero to 40 milliamps. The above components associated with LED 16 are drive electronics 21. For one embodiment, a Lumex SSL-509XRC/4 LED is used. It has a relatively high intensity, narrow beam width and an orange/red wavelength. However, as indicated above, any suitable light source may be used.

In the illustrative embodiment, detector 20 is a photo transistor L14P that is connected as a photo diode. LED 16 and detector 20 are situated about ½ inch from each other within enclosure 12 of FIG. 1. A 2K ohm resistor 31 across the detector 20 terminals may be provided to help limit or prevent saturation of detector 20 in bright light (e.g., the sun) and the AC coupling capacitor 32 may block the DC level of ambient light to amplifier 22. Amplifier 22 amplifies the LED induced signal from detector 20. An LM2340 operational amplifier 34, which is a component of amplifier 22, was selected for its single power supply, low noise, wide bandwidth, high slew rate and rail-to-rail I/O. In some embodiments, it may be desirable to provide a balance of signal gain and reduction of noise in amplifier 22. A 100K ohm resistor 35 may connect the inverting input of operational amplifier 34 to the 2.5 volt DC supply. A 0.0022 microfarad capacitor 33 across feedback 402 K ohm resistor 61 may be used to help limit the amplifier 34 gain at high frequencies.

In the illustrative embodiment, detector 20 utilizes a Fairchild L14P2 photo transistor in a narrow angle T018 package. However, as indicated above, any suitable light detector may be used. Shielding may be provided for the detector 20 to help limit or prevent cross-talk between LED 16 and photo detector 20. Such shielding may also help shield the detector from ambient light.

In the illustrative embodiment, bandpass filter 23 has a center frequency of about one KHz and provides additional gain at one KHz. Filter 23 may help reduce the effect of power line frequency, radio frequencies, and other frequencies of lighting that detector 22 may be exposed to or receive. An input 0.0047 microfarad coupling capacitor 36 may be provided to help reduce low frequency signals to filter 23. This embodiment may include a 10K ohm resistor 37 which has one end connected to capacitor 36 and the non-inverting input of an LM2340 operational amplifier 38, and the other end connected to the 2.5 volt reference. A 150K ohm feedback resistor 39 may be connected between the output and the inverting input of amplifier 38. Two 0.01 microfarad capacitors 40 and 41 may be connected in series from the output to the inverting input of amplifier 38, with the common connection of capacitors 40 and 41 connected to one end of a 1.5K ohm resistor 42. The other end of resistor 42 may be connected to the +2.5 volt DC source. The capacitors and resistors may set the center frequency and gain of the filter.

The output of filter 23 may go to a non-inverting input of integrated circuit AD8307 logarithmic amplifier 45 via a 1.2 microfarad capacitor 43 and a one K ohm resistor 44 connected in series. The non-inverting input of amplifier 45 can be connected to the inverting input of amplifier 45 with a 0.01 microfarad capacitor 46 and a 10K ohm resistor 47 connected to each other in parallel. Also, the non-inverting input may be connected to ground via a one K-ohm resistor 48 and a 1.2 microfarad capacitor 49 connected in series with each other. The RC filtering may be for reducing high frequency signals to logarithmic amplifier 45. Logarithmic amplifier 45 has a series of amplifiers, detector cells and other circuits to help convert the input signal to a DC output at a slope of about 25 millivolts per dB.

The output of amplifier 45 may go to a non-inverting input of an LM2340 operational amplifier 50 via a 20K ohm resistor 51. The output of amplifier 45 may be connected to ground through a 1.2 microfarad capacitor 52 for output signal filtering. The output of amplifier 50 may be fed back to the inverting input via a 402 K ohm resistor 53 connected in parallel with a 1.2 microfarad capacitor 54. Also, the inverting input of amplifier 50 may be connected to ground via a 499K ohm resistor 55. Amplifier 50 may output a light level indication signal 27 which goes to controller 56. Controller 56 may determine when source 16 should be turned on or off. Also, controller 56 may have a meter or readout electronics 60, and the drive and control electronics for an electrochromic window if that is what the transmitivity sensor is used for. Operational amplifier 50 may provide a gain of 1.8 and along with buffers and filter networks to filter output 27.

Although the invention has been described with respect to at least one illustrative embodiment, many variations and modifications will become apparent to those skilled in the art upon reading the present specification. It is therefore that the appended claims be interpreted broadly as possible in view of the prior art to include all such variations and modifications.

What is claimed is:

1. A transmission sensor comprising:
a source;
a detector; and
a reflector situated so as to reflect a signal from said source to said detector.

2. The transmission sensor of claim 1, wherein said sensor has a medium situated between said reflector and said source.

3. The transmission sensor of claim 1, wherein a medium is situated between said reflector and said detector.

4. The transmission sensor of claim 3, wherein the medium is situated between said reflector and said source.

5. The transmission sensor of claim 4, wherein:
said reflector is situated on a first side of the medium; and
said source and said detector are situated on a second side of the medium.

6. The transmission sensor of claim 5, further comprising a processor connected to said detector.

7. The transmission sensor of claim 6, wherein said processor can indicate the amount of transmittance of the medium for the signal.

8. The transmission sensor of claim 7, wherein the signal has a wavelength.

9. The transmission sensor of claim 8, wherein the wavelength is that of light.

10. The transmission sensor of claim 9, wherein said reflector is a corner reflector.

11. The transmission sensor of claim 10, wherein:
said source is a light emitting diode; and
said detector is a photo detector.

12. The transmission sensor of claim 11, wherein said processor comprises:
drive electronics connected to said source;
an amplifier connected to said detector;
a filter connected to said detector; and
a logarithmic amplifier connected to said filter.

13. The transmission sensor of claim 12, further comprising readout instrumentation connected to said logarithmic amplifier.

14. The transmission sensor of claim 13, wherein said readout instrumentation can indicate the amount of transmittance of the signal through the medium.

15. The transmission sensor of claim 14, wherein no physical connection is necessary between the first side and the second side of the medium for the transmission sensor to indicate the amount of transmittance of the signal through the medium.

16. The transmission sensor of claim 15, wherein the medium is a window.

17. The transmission sensor of claim 16, wherein the medium is an electrochromic window having a variable transmittance which is measurable by the transmission sensor.

18. A transmission sensor for measuring transmitivity of a medium, comprising:
a reflector located on a first side of the medium;
a source located on a second side of the medium;
a detector located on the second side of the medium.

19. The transmission sensor of claim 18, wherein:
said source emanates radiation through the medium to said reflector; and
said reflector reflects the radiation through the medium to said detector.

20. The transmission sensor of claim 19, wherein a magnitude of radiation detected by said detector is indicative of the transmitivity of th e medium.

21. The transmission sensor of claim 20, further comprising a processor connected to said source and detector.

22. The transmission sensor of claim 21, further comprising readout instrumentation connected to said processor.

23. The transmission sensor of claim 22, wherein said medium is an electrochromic device.

24. The transmission sensor of claim 23, wherein the radiation is light.

25. A method for measuring the transmitivity of a medium comprising:
emitting radiation through a first surface of the medium;
reflecting the radiation from a second surface of the medium through the second surface of the medium; and
detecting the radiation from the first surface of the medium.

26. The method of claim 25, wherein the magnitude of the radiation from the first surface of the medium is measure of the transmitivity of the medium.

27. A method for measuring the transmitivity of a medium comprising:
emitting radiation through a medium;
reflecting the radiation back through the medium;
measuring a magnitude of the radiation reflected back through the medium.

28. A transmission sensor comprising:
means for emitting radiation through an object;
means for reflecting the radiation from the object back through the object; and
means for measuring the radiation reflected back through the object.

29. The transmission sensor of claim 28, further comprising means for processing the measured radiation reflected back through the object into an indication of the transmitivity of the object.

30. A transmission sensor for measuring the transmitivity of light through a window with connections on only a first side of the window, comprising:
a light source proximate to the first side of the window;
a reflector proximate to a second side of the window;
a detector proximate to the first side of the window; and
a transmitivity level indicator connected to said light detector.

31. The transmission sensor of claim 30, wherein the window is capable of having a variable transmitivity.
